(19) United States
(12) Patent Application Publication
(10) Pub. No.: US 2026/0094259 A1
(43) Pub. Date: Apr. 2, 2026

(54) COMPUTER-READABLE RECORDING MEDIUM HAVING STORED THEREIN INSPECTION PROGRAM AND INSPECTION DEVICE

(71) Applicant: Robit Inc., Tokyo (JP)

(72) Inventors: Masahiro ARAI, Tokyo (JP); Kaoru KAWAKITA, Tokyo (JP); Ryuichi HIRANO, Tokyo (JP)

(73) Assignee: Robit Inc., Tokyo (JP)

(21) Appl. No.: 19/393,686

(22) Filed: Nov. 19, 2025

Related U.S. Application Data
(63) Continuation of application No. PCT/JP2023/019408, filed on May 24, 2023.

(51) Int. Cl. G06T 7/00

(52) U.S. Cl. CPC G06T 7/0008; G06T 2207/30128

(57) ABSTRACT

A non-transitory computer readable recording medium has stored therein an inspection program that causes a computer that is to inspect a target object to execute a method, the method including setting a threshold to specify whether the target object is a normal object or an abnormal object in accordance with an abnormal level of the target object, determining an abnormal level of the target object by applying a captured image of the target object to a machine learning model, and specifying the target object to be the abnormal object if the target object includes a part having the determined abnormal level equal to or more than a threshold set for each of a plurality of abnormal types having possibility of occurring at a same part of the target object.

### CROSS-REFERENCE TO RELATED APPLICATION

This application is a continuation application of International Application PCT/JP2023/019408 filed on May 24, 2023 and designated the U.S., the entire contents of which are incorporated herein by reference.

### FIELD

The embodiment discussed herein relates to a computer-readable recording medium having stored therein an inspection program and an inspection device.

### BACKGROUND

When inspecting a workpiece, an Artificial Intelligence (AI) is sometimes used to detect an abnormality (in other words, some specific parts) exists on a captured image of the workpiece.

Such abnormality detection employing an AI outputs the probability that an abnormality exists and, if an abnormality exists, the type of the abnormality, for example.

### RELATED ART DOCUMENT

### Patent Document

Patent Document 1: Japanese Laid-open Patent Application No. 2021-182225
Patent Document 2: Japanese Laid-open Patent Application No. 2021-131364

### SUMMARY

According to an aspect of the embodiment, a non-transitory computer readable recording medium has stored therein an inspection program that causes a computer that is to inspect a target object to execute a process including setting a threshold to specify whether the target object is a normal object or an abnormal object in accordance with an abnormal level of the target object, determining an abnormal level of the target object by applying a captured image of the target object to a machine learning model, and specifying the target object to be the abnormal object if the target object includes a part having the determined abnormal level equal to or more than a threshold set for each of a plurality of abnormal types having possibility of occurring at a same part of the target object.

### BRIEF DESCRIPTION OF DRAWINGS

FIG. 1 is a diagram illustrating level images of shriveling of an almond;

FIG. 2 is a block diagram illustrating examples of a hardware configuration and a functional configuration of an inspection system according to an embodiment;

FIG. 3 is a diagram illustrating an example of a setting screen of an abnormal level of the embodiment;

FIG. 4 is a diagram illustrating an example of a map of an input image of the embodiment;

FIG. 5A is a diagram illustrating an example of an abnormality degree, FIG. 5B is a diagram illustrating an example of an abnormal level, FIG. 5C is a map illustrating an example of a map of an abnormal type #1, FIG. 5D is a map illustrating an example of a map of an abnormal type #2, and FIG. 5E is a map illustrating an example of a map of an abnormal type #3;

FIG. 6A is a diagram illustrating an evaluating process of an abnormal map, FIG. 6B is a diagram illustrating a selecting process of an abnormal type, and FIG. 6C is a diagram illustrating a determining process of a final determination according to an abnormal level;

FIG. 7 is a flowchart illustrating an abnormality inspecting process of the embodiment;

FIG. 8 is a flowchart illustrating a preprocessing on an input image of the embodiment; and

FIG. 9 is a flowchart illustrating a machine learning process of the embodiment.

### DESCRIPTION OF EMBODIMENTS

However, demands sometimes arise for flexible selection of a workpiece as an abnormal object or a normal object according to the level of the abnormality (in other words, the severity) in addition to the presence or absence of an abnormality and the type of the abnormality.

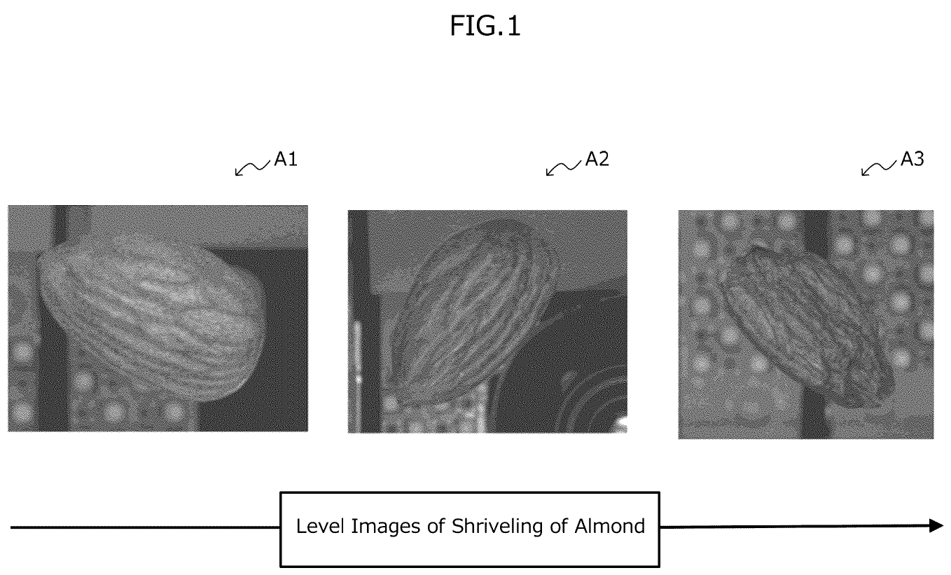

FIG. 1 is a diagram illustrating level images of shriveling of an almond.

FIG. 1 illustrates three images of an almond the surfaces of which have higher levels of shriveling in an ascending order of the reference signs A1, A2, and A3.

For example, as indicated by the reference sign A2, an almond that can be treated as a normal object exists because the whole part of the almond shrivels but the shriveling is slight. On the other hand, as indicated by the reference sign A3, an almond that is to be treated as an abnormal object exits because the whole part of the almond largely shrivels.

The boundary of an abnormal level determined to be a normal object may vary with the application of the workpiece, which requires to prepare multiple machine learning data according to the applications of selection of workpieces.

For example, almonds may be used as a bar snack or be solely placed on a western confectionery. It is expected that an almond slightly shriveling is allowed and selected as a bar snack but is not allowed and not selected for the application of being solely placed on a western confectionery.

Referring to the drawings, an embodiment will be described. The following embodiment is merely illustrative and is not intended to exclude the application of various modifications and techniques not explicitly described in the embodiments. The present embodiments can be variously modified and implemented without departing from the scopes thereof.

Each drawing does not intend to include only the elements appearing therein, but may include additional functions.

Hereinafter, like reference throughout the drawings designate the same or substantially the same parts and elements.

### A. EMBODIMENT

### A-1. Example of System Configuration

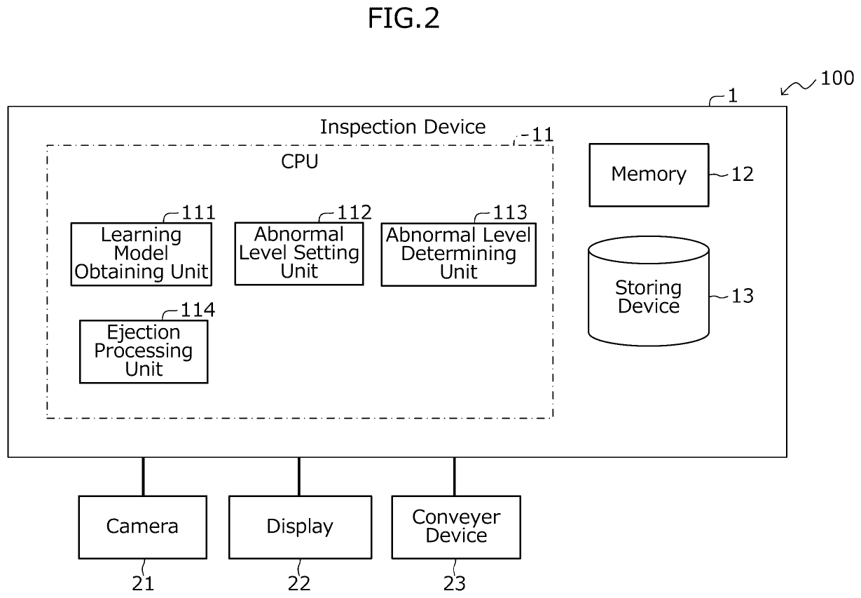

FIG. 2 is a block diagram illustrating examples of a hardware configuration and a functional configuration of an inspection system 100 according to the embodiment.

The inspection system 100 includes an inspection device 1, a camera 21, a display 22, and a conveyer device 23.

The camera 21 captures an image of a workpiece (target object; not illustrated) that is to be inspected by the inspection device 1, and inputs the captured image into the inspection device 1. The inspection system 100 may be provided with a single camera 21 or multiple cameras 21. Examples of the workpiece are plant such as fruits and vegetables, animals, and industrial products.

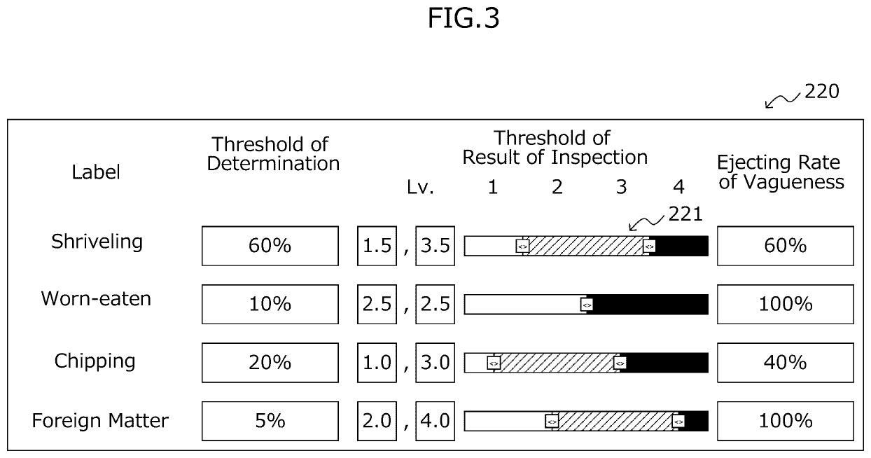

The display 22 displays various types of information to an operator of the inspection device 1. The display 22 displays a setting screen 220 to be described below with reference to FIG. 3.

The conveyer device 23 transfers the workpiece to a position where the camera 21 can capture an image of the workpiece. The conveyer device 23 may include an ejection mechanism to eject abnormal workpieces.

If the workpiece is light in weight and hardly breaks, the conveyer device 23 may include a blowing unit. The conveyer device 23 causes the camera 21 to capture an image of the workpiece while the workpiece is blown to be conveyed by the blowing unit. The blowing unit may achieve the function as an ejecting mechanism by blowing a normal workpiece and an abnormal workpiece to different positions (in other words, different distances) by adjusting an air volume to be output. If the conveyer device 23 includes a blowing unit for conveyance and a blowing unit for ejection, the function as the ejecting mechanism may be achieved by blowing a normal workpiece and an abnormal workpiece to different positions by the blowing unit for conveyance and the blowing unit for ejection blowing air to respective different directions.

In addition, the conveyer device 23 may include a conveyer and may cause the camera 21 to capture an image of the workpiece while the workpiece is being conveyed by the conveyer. This configuration may eject an abnormal workpiece by a blowing unit that blows air to a direction perpendicular to the conveying direction of the conveyer or by a robotic arm that grasps the workpiece or a flap that flicks the workpiece, for example.

The conveyer device 23 may include an abnormality notifying unit in place of an ejecting mechanism. The abnormality notifying unit may notify, when an abnormal workpiece is detected, the operator of the inspection system 100 of the detection of abnormal workpiece. The abnormality notifying unit may notify the operator of an abnormality by means of screen display on the display 22, alert sound, and a lamp, for example.

The inspection device 1 includes a Central Processing Unit (CPU) 11, a memory 12, and a storing device 13.

The storing device 13 is illustratively a device that readably and writably stores data and may be exemplified by a Hard Disk Drive (HDD), a Solid State Drive (SSD), and a Storage Class Memory (SCM). The storing device 13 stores a machine learning model to execute an abnormality inspecting process of the embodiment.

The memory 12 is illustratively a storing device including a Read Only Memory (ROM) and a Random Access Memory (RAM). The RAM may be a Dynamic RAM (DRAM). Into the ROM of the memory 12, a program such as a Basic Input/Output System (BIOS) may be written. The software program of the memory 12 may be appropriately read and then executed by the CPU 11. The RAM of the memory 12 may be used as a primary recording memory or a working memory.

The CPU 11 is an example of a processor and is illustratively a processing device that executes various controls and arithmetic operations. The CPU 11 achieves various functions by executing an Operating System (OS) and a program read by the memory 12. This means that, as illustrated in FIG. 1, the CPU 11 may function as a learning model obtaining unit 111, an abnormal level setting unit 112, an abnormal level determining unit 113, and an ejection processing unit 114.

The program to exert the functions of the learning model obtaining unit 111, the abnormal level setting unit 112, the abnormal level determining unit 113, and the ejection processing unit 114 may be provided in the form of being recorded in a computer-readable recording medium such as a flexible disk, a CD (e.g., CD-ROM, CD-R, CD-RW), a DVD (e.g., DVD-ROM, DVD-RAM, DVD-R, DVD+R, DVD-RW, DVD+RW, HD DVD), a Blu-ray Disc, a magnetic disc, an optical disc, and a magneto-optical disc. A computer (in this embodiment, the CPU 11) reads the program from the above recording medium by a non-illustrated reader and forwards and stores the read program to and in an internal or external recording device for future use. Alternatively, the program may be stored in a storing device (recording medium) such as a magnetic disc, an optical disc, or a magneto-optical disc, and provided from the storing device to the computer via a communication path.

In exerting the functions of the learning model obtaining unit 111, the abnormal level setting unit 112, the abnormal level determining unit 113, and the ejection processing unit 114, a program stored in an internal storing device (in this embodiment, the memory 12) may be executed by the computer (in this embodiment, the CPU 11). Alternatively, the computer may read the program recorded in a recording medium and execute the read program.

The learning model obtaining unit 111 generates a machine learning model to execute an abnormality inspecting process of the embodiment and stores the machine learning model into the storing device 13. The learning model obtaining unit 111 obtains the machine learning model stored in the storing device 13. The present embodiment implements one machine learning model that can be used in multiple selecting applications by appropriately adjusting thresholds.

The abnormal level setting unit 112 sets information of a threshold of determination, a threshold of a result of the inspection, and an ejection rate of vagueness based on an input from an operator using the setting screen 220 to be described below with reference to FIG. 3.

The abnormal level determining unit 113 determines an abnormal level if an abnormality exists in each work on the basis of a machine learning model acquired by the learning model obtaining unit 111 and an input by the camera 21.

The ejection processing unit 114 ejects a workpiece determined to be an abnormal object on the basis of the setting by the abnormal level setting unit 112 and the result of determining the abnormality level by the abnormal level determining unit 113.

In addition, the ejection processing unit 114 may eject some workpieces that are determined to be vague between an abnormal object and a normal object. For example, if an almond that is largely chipped is allowed to be included up to 10% of the total, objects having the abnormal level 1 to 2 are determined to be normal objects, objects having the abnormal level 2 to 3 are determined to be vague and ejected at a rate 90%, and objects the abnormal level 3 or higher is determined to be abnormal objects and all ejected.

FIG. 3 is a diagram illustrating an example of a setting screen 220 for an abnormal level of the embodiment.

On the setting screen 220 of FIG. 3, the operator of the inspection system 100 inputs values using a keyboard or a mouse (not illustrated).

The setting screen 220 displays a threshold of determination, threshold of the result of determination, and an ejection rate of vagueness.

In the example of FIG. 3, the field of label displays “shriveling”, “worn-eaten”, “chipping”, and “foreign matter”.

In the field of threshold of the determination, a rate of a possibility that each workpiece is an abnormal object for each corresponding label is set.

In the field of threshold of a result of the inspection, a threshold for determining each workpiece is a normal object, a vague object, or an abnormal object for each label is set on the basis of the abnormal level of each workpiece.

In FIG. 3, for example, with respect to label “shriveling”, the threshold of a result of the inspection indicates that the abnormality level less than 1.5 is a normal object (see white region of an indicator 221), the abnormality level greater than or equal to 1.5 and less than 3.5 is a vague object (see oblique line region of the indicator 221), and the abnormality level greater than or equal to 3.5 is an abnormal object (see black region of the indicator 221).

The vague object may be referred to as an intermediate object having intermediate quality between a normal object and an abnormal object.

In threshold of a result of the inspection, the value such as “1.5” (second threshold) or “3.5” (first threshold) may be directly input to input boxes, or the value may be adjusted by operating the indicator 221.

In addition, in FIG. 3, for example, with respect to label “worm-eaten”, the threshold of a result of the inspection indicates that the abnormality level less than 2.5 is a normal object (see white region of the indicator 221) and the abnormality level equal to or more than 2.5 is an abnormal object (see black region of the indicator 221). As the above, the setting for a vague object is not always required.

The ejection rate of vagueness is set as how many parts of workpieces determined to be vague objects are to be ejected.

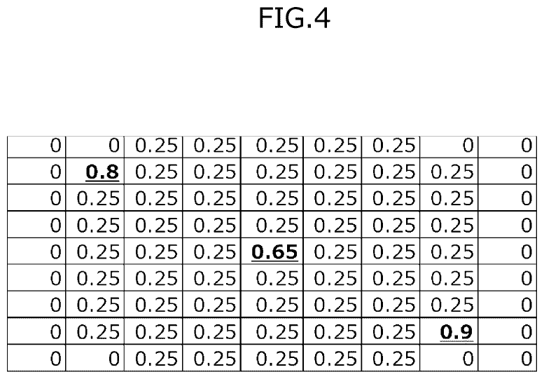

FIG. 4 is a diagram illustrating an example of a map of an input image of the embodiment.

In FIG. 4, the luminance of the monochrome image normalization by [0, 1] is expressed in a 9×9 map. The input image may be a multi-color image.

In the example of FIG. 4, the value “0” represents a part in which no workpiece exists, the value “0.25” represents a part in which an image of a normal part of a workpiece is captured, the value “0.8” represents a part in which an abnormal part A exits, the value “0.65” represents a part in which an abnormal part B exits, and the value “0.9” represents a part in which an abnormal part C.

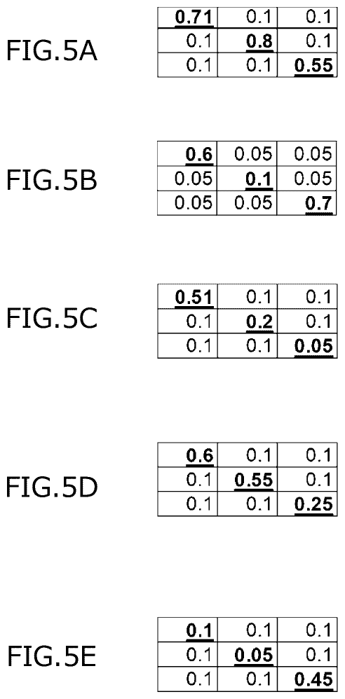

FIG. 5A is a diagram illustrating an example of an abnormality degree, FIG. 5B is a diagram illustrating an example of an abnormal level, FIG. 5C is a map illustrating an example of a map of an abnormal type #1, FIG. 5D is a map illustrating an example of a map of an abnormal type #2, and FIG. 5E is a map illustrating an example of a map of an abnormal type #3.

In the example of FIGS. 5A-5E, the cell resolution is assumed to be 3×3, which is ⅓ the resolution of the map of the input image of FIG. 4. The cell resolution of the map of FIGS. 5A-5E is not limited to 3×3, may be lower or higher than 3×3, and further may be the same as the map (9×9 in the example of FIG. 4) of the input image.

In FIG. 5A, an abnormality degree represents a probability that an abnormality exists as a result of evaluating an image by machine learning. In the example of FIG. 5A, a part with the abnormal part A has an abnormality degree of 0.71, a part with the abnormal part B has an abnormality degree of 0.8, and a part with the abnormal part C has an abnormality degree of 0.55.

In FIG. 5B, the abnormal level represents the extent of abnormality if an abnormality is found as a result of evaluating the image by machine learning. In the example of FIG. 5B, a part with the abnormal part A has an abnormal level of 0.6, a part with the abnormal part B has an abnormal level of 0.1, and a part with the abnormal part C has an abnormal level of 0.95.

In FIGS. 5C-5E, the abnormal type corresponds to the labels illustrated in FIG. 3.

In the example of FIG. 5C, a part with the abnormal part A has an abnormal type #1 of 0.51, a part with the abnormal part B has an abnormal type #1 of 0.2, and a part with the abnormal part C has an abnormal type #1 of 0.05.

In the example of FIG. 5D, a part with the abnormal part A has an abnormal type #2 of 0.6, a part with the abnormal part B has an abnormal type #2 of 0.55, and a part with the abnormal part C has an abnormal type #2 of 0.25.

In the example of FIG. 5E, a part with the abnormal part A has an abnormal type #3 of 0.1, a part with the abnormal part B has an abnormal type #3 of 0.05, and a part with the abnormal part C has an abnormal type #3 of 0.45.

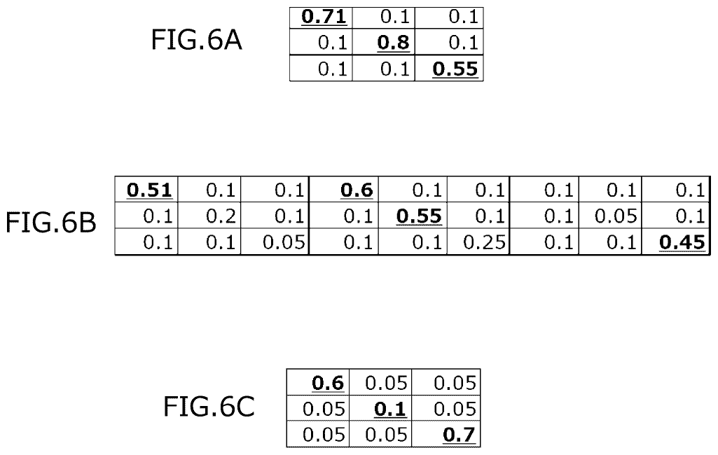

FIG. 6A is a diagram illustrating an evaluating process of an abnormal map, FIG. 6B is a diagram illustrating a selecting process of an abnormal type, and FIG. 6C is a diagram illustrating a determining process of a final determination according to an abnormal level.

The thresholds of the abnormality degrees the abnormal types #1 to #3 are assumed to be 0.7, 0.6, and 0.51, respectively.

In the abnormality degree map of FIG. 6A, a cell exceeding the lowest value (0.51 of the abnormal type #3 in this example) among the thresholds of the abnormality degrees of the respective abnormal types is selected. The cell having an abnormality degree 0.71 is set to the “cell #1”, the cell having an abnormality degree 0.8 is set to the “cell #2”, and the cell having an abnormality degree 0.55 is set to the “cell #3”.

In the selection of the abnormal type illustrated in FIG. 6B, the maps of the abnormal types #1 to #3 are aligned, and a value exceeding threshold (0.5 in this example) is selected at the same coordinate as the coordinate of the cell selected in FIG. 6A from each map. In the example of FIG. 6B, 0.51 in the map of the abnormal type #1 and 0.6 and 0.55 in the map of the abnormal type #2 are selected as the values exceeding the threshold 0.5. On the other hand, in the map of the abnormal type #3, since there is no value exceeding threshold 0.5 at the same coordinates as the coordinates of the cell selected in FIG. 6A, one of the largest values 0.45 is selected.

In determining the final evaluation according to the abnormal level illustrated in FIG. 6C, if the abnormal type #1 having an abnormal level of 0.5 or more is determined to be abnormal, the abnormal type #2 having an abnormal level of 0.05 to 0.56 is determined to be vague and having an abnormal level equal to or more than 0.56 is determined to be abnormal and the abnormal type #3 having an abnormal level less than 0.75 is determined to be normal, the cell #1 is determined to be abnormal in regard of the abnormal types #1 and #2, and the cell #5 is determined to be vague in regard of the abnormal types #3, and the cell #9 is determined to be normal in regard of the abnormal type #3.

### A-2. Example of Operation

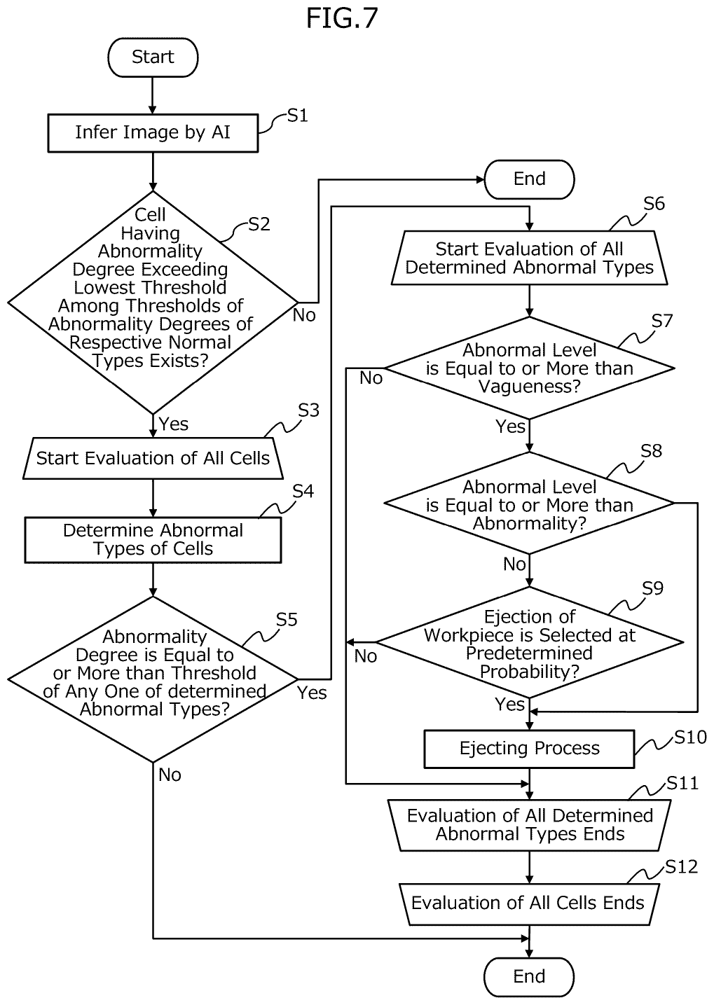

Description will now be made in relation to an abnormality inspecting process of the present embodiment with reference to a flow chart (Steps S1-S12) of FIG. 7.

The abnormal level determining unit 113 infers an image by an AI (Step S1).

The abnormal level determining unit 113 determines whether a cell having an abnormality degree exceeding the lowest threshold among the thresholds of the abnormality degrees of the respective normal types exists (Step S2).

If no cell having an abnormality degree exceeding the lowest threshold among the thresholds of the abnormality degrees of the respective normal types exists (see No route of Step S2), the abnormal inspecting process ends.

On the other hand, if a cell having an abnormality degree exceeding the lowest threshold among the thresholds of the abnormality degrees of the respective normal types exists (see Yes route of Step S2), the process of Steps S4-S11 is repeatedly executed and evaluation of all the cells having an abnormality degree exceeding the lowest threshold is started (Step S3). Alternatively, the evaluation may be performed on all the cells including cells not having an abnormality degree exceeding the lowest threshold.

The abnormal level determining unit 113 determines the abnormal types of the cells (Step S4).

The abnormal level determining unit 113 determines whether the abnormality degree is equal to or more than the threshold of any one of the determined abnormal types (Step S5).

If the abnormal level is not equal to or more than the threshold of any one of the determined abnormal types (see No route in Step S5), the process proceeds to Step S12.

On the other hand, if the abnormal level is equal to or more than the threshold of any one of the determined abnormal types (see Yes route in Step S5), the process of Steps S7-S10 is repeatedly executed, and the evaluation of all the determined abnormal types is started (Step S6).

The abnormal level determining unit 113 determines whether the abnormal level is equal to or more than vagueness (Step S7).

If the abnormal level is not equal to or more than vagueness (see No route in Step S7), the process proceeds to step S11.

On the other hand, if the abnormal level is equal to or more than vagueness (see Yes route in Step S7), the abnormal level determining unit 113 determines whether the abnormal level is equal to or more than the abnormality (Step S8).

If the abnormal level is equal to or more than the abnormality (see Yes route in Step S8), the process proceeds to Step S10.

On the other hand, if the abnormal level is not equal to or more than the abnormality (see No route in Step S8), the ejection processing unit 114 determines whether or not ejection is selected at a predetermined probability (Step S9).

If ejection is not selected at a predetermined probability (see No route in Step S9), the process proceeds to step S11.

On the other hand, if ejection is selected at the predetermined probability (see Yes route in Step S9), the ejection processing unit 114 executes the ejecting process (Step S10).

If the evaluation of all the determined abnormal types has been repeatedly executed in Steps S7-S10, the evaluation of all the determined abnormal types ends (Step S11).

If the evaluation of all the cells has been repeatedly executed in Steps S4-S11, evaluation of all the cells having abnormality degree exceeding lowest threshold ends (Step S12). Then, the abnormal inspecting process ends.

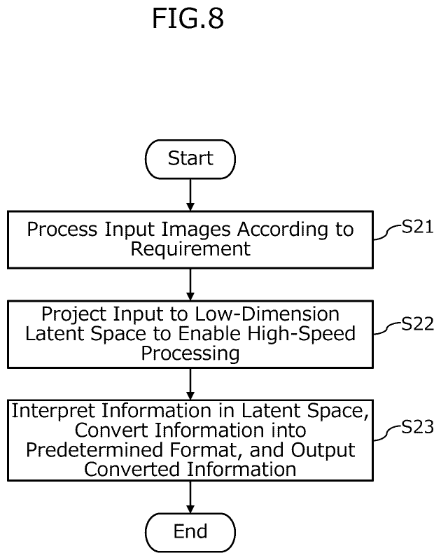

Next, description will now be made in relation to a preprocessing on an input image of the present embodiment with reference to a flow chart (Steps S21-S23) of FIG. 8.

The abnormal level determining unit 113 functions as an image input unit that processes an input image according to a requirement (step S21).

The abnormal level determining unit 113 also functions as a latent space projecting unit that project an input on a low-dimension latent space to enable high-speed process (Step S22).

The abnormal level determining unit 113 also functions as an output unit that interprets information of the latent space, converts the information into a predetermined format, and outputs the converted information (Step S23). Then, the preprocessing of the input image ends.

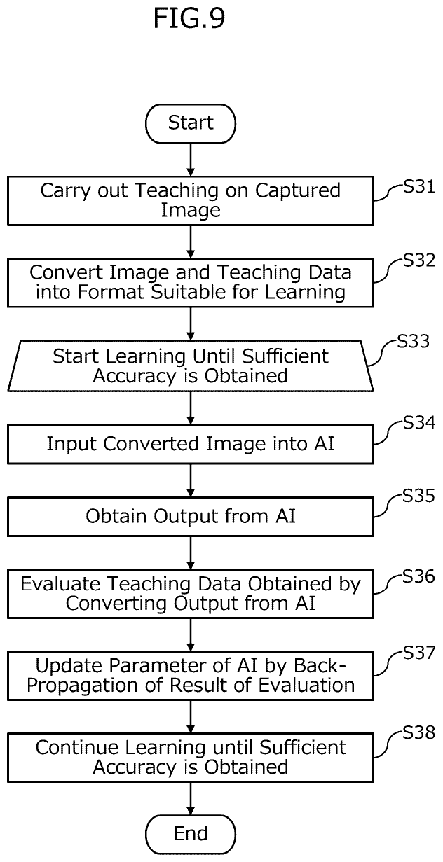

Next, description will now be made in relation to a machine learning process of the present embodiment with reference to a flow chart (Steps S31-S38) of FIG. 9.

After a sample is placed on the inspection system 100 and an image of the sample is captured the camera 21 so that a sample for learning is photographed, the learning model obtaining unit 111 carries out teaching on an image-captured data (Step S31). Specifically, the learning model obtaining unit 111 teaches the abnormal type and the abnormal level to an abnormal part of the image, and performs a process called Semantic Segmentation or Bounding Box only on the abnormal part.

The learning model obtaining unit 111 converts the image and teaching data into format, such as a map of [0, 1], suitable for learning (Step S32).

The process of Steps S34-S37 is repeatedly executed to start learning until sufficient accuracy is obtained (Step S33).

The learning model obtaining unit 111 inputs the converted image to the AI (Step S34).

The learning model obtaining unit 111 obtains an output from the AI (Step S35).

The learning model obtaining unit 111 evaluates teaching data obtained by converting the output from the AI (Step S36).

The learning model obtaining unit 111 back-propagates the result of the evaluation and updates a parameter of the AI (Step S37).

If the learning has been repeatedly executed in Steps S34-S37 until sufficient accuracy is obtained, the learning until sufficient accuracy is obtained ends (Step S38). Then, the machine learning process ends.

### A-3. Advantageous Effect

The inspection program and the inspection device 1 according to an example of the above embodiment can bring the following effects.

The abnormal level setting unit 112 sets a threshold to specify whether the target object is a normal object or an abnormal object in accordance with an abnormal level of the target object. The abnormal level determining unit 113 determines an abnormal level of the target object by applying a captured image of the target object to a machine learning model. The abnormal level determining unit 113 specifies the target object to be the abnormal object if the target object includes a part having the determined abnormal level equal to or more than a threshold set for each of multiple abnormal types having possibility of occurring at a same part of the target object.

This enables flexible selection for workpieces using a single machine learning model regardless of the applications of selection of workpieces. In addition, this enables appropriately selection for workpieces according to an abnormality level for each of the multiple abnormal types.

The state of the target object includes the normal object, the abnormal object, and an intermediate object having quality between the normal object and the abnormal object. The threshold includes a first threshold to specify whether the target object is the abnormal object or the intermediate object and a second threshold to specify whether the target object is the intermediate object or the normal object. The abnormal level determining unit 113 specifies the target object to be the abnormal object if the target object includes a part having the determined abnormal level equal to or more than the first threshold, specifies the target object to be the intermediate object if the target object includes a portion having the determined abnormal level equal to or more than the second threshold and less than the first threshold and is not specified to be the abnormal object, and specifies the target object to be the normal object if the target object includes a portion having the determined abnormal level less than the second threshold and is not specified to be the abnormal object or the intermediate object.

This enables an appropriate specification of an intermediate object (i.e., vague object) having quality between the quality of the normal object and the quality of the abnormal object.

The abnormal level setting unit 112 sets the multiple ejection rates one for each of the multiple abnormal types. The ejection processing unit 114 ejects a part of the intermediate objects among multiple the target objects according to the rejecting rate in addition to all of the abnormal object.

This can eject the intermediate objects at an appropriate rate.

The abnormal level setting unit 112 set the multiple thresholds one for each of the multiple abnormal types. The abnormal level determining unit 113 determines the multiple abnormal levels one for each of the multiple abnormal types. The abnormal level determining unit 113 specifies that the target object is the abnormal object if the target object includes a part having multiple determined abnormal levels each equal to or more than a corresponding one of the multiple thresholds.

This enables accurate specification of an abnormal object by determining multiple abnormal levels of each abnormal type.

### B. MISCELLANEOUS

The disclosed techniques are not limited to the embodiment described above, and may be variously modified without departing from the scope of the present embodiment. The respective configurations and processes of the present embodiment can be selected, omitted, and combined according to the requirement.

The disclosed technique enables flexible selection for workpieces using a single machine learning model regardless of the applications of selection of workpieces.

What is claimed is:

1. A non-transitory computer readable recording medium having stored therein an inspection program that causes a computer that is to inspect a target object to execute a method, the method comprising:
setting a threshold to specify whether the target object is a normal object or an abnormal object in accordance with an abnormal level of the target object;
determining an abnormal level of the target object by applying a captured image of the target object to a machine learning model; and
specifying the target object to be the abnormal object if the target object includes a part having the determined abnormal level equal to or more than a threshold set for each of a plurality of abnormal types having possibility of occurring at a same part of the target object.

2. The non-transitory computer readable recording medium according to claim 1, wherein
the state of the target object includes the normal object, the abnormal object, and an intermediate object having quality between the normal object and the abnormal object,
the threshold includes a first threshold to specify whether the target object is the abnormal object or the intermediate object and a second threshold to specify whether the target object is the intermediate object or the normal object,
the method further comprising:
specifying the target object to be the abnormal object if the target object includes a part having the determined abnormal level equal to or more than the first threshold,
specifying the target object to be the intermediate object if the target object includes a portion having the determined abnormal level equal to or more than the second threshold and less than the first threshold and is not specified to be the abnormal object, and
specifying the target object to be the normal object if the target object includes a portion having the determined abnormal level less than the second threshold and is not specified to be the abnormal object or the intermediate object.

3. The non-transitory computer readable recording medium according to claim 2, the method further comprising:
setting an ejecting rate of the intermediate object for each of the plurality of abnormal types; and
ejecting a part of the intermediate objects among a plurality of the target objects according to the rejecting rate in addition to all of the abnormal object.

4. The non-transitory computer readable recording medium according to claim 1, the method further comprising:
setting a plurality of the thresholds one for each of the plurality of abnormal types;
determining a plurality of the abnormal levels one for each of the plurality of abnormal types; and
specifying that the target object is the abnormal object if the target object includes a part having a plurality of determined abnormal levels each equal to or more than a corresponding one of the plurality of thresholds.

5. The non-transitory computer readable recording medium according to claim 2, the method further comprising:
setting a plurality of the thresholds one for each of the plurality of abnormal types;
determining a plurality of the abnormal levels one for each of the plurality of abnormal types; and
specifying that the target object is the abnormal object if the target object includes a part having a plurality of determined abnormal levels each equal to or more than a corresponding one of the plurality of thresholds.

6. The non-transitory computer readable recording medium according to claim 3, the method further comprising:
setting a plurality of the thresholds one for each of the plurality of abnormal types;
determining a plurality of the abnormal levels one for each of the plurality of abnormal types; and
specifying that the target object is the abnormal object if the target object includes a part having a plurality of determined abnormal levels each equal to or more than a corresponding one of the plurality of thresholds.

7. An inspection device that inspects a target object comprising:
a memory; and
processor circuitry being coupled to the memory and being configured to:
set a threshold to specify whether the target object is a normal object or an abnormal object in accordance with an abnormal level of the target object;
determine an abnormal level of the target object by applying a captured image of the target object to a machine learning model; and
specify the target object to be the abnormal object if the target object includes a part having the determined abnormal level equal to or more than a threshold set for each of a plurality of abnormal types having possibility of occurring at a same part of the target object.

8. The inspection device according to claim 7, wherein
the state of the target object includes the normal object, the abnormal object, and an intermediate object having quality between the normal object and the abnormal object,
the threshold includes a first threshold to specify whether the target object is the abnormal object or the intermediate object and a second threshold to specify whether the target object is the intermediate object or the normal object, and
the processor circuitry is further configured to
specify the target object to be the abnormal object if the target object includes a part having the determined abnormal level equal to or more than the first threshold,
specify the target object to be the intermediate object if the target object includes a portion having the determined abnormal level equal to or more than the second threshold and less than the first threshold and is not specified to be the abnormal object, and
specify the target object to be the normal object if the target object includes a portion having the determined abnormal level less than the second threshold and is not specified to be the abnormal object or the intermediate object.

9. The inspection device according to claim 8, wherein the processor circuitry is further configured to:
set an ejecting rate of the intermediate object for each of the plurality of abnormal types; and
eject a part of the intermediate objects among a plurality of the target objects according to the rejecting rate in addition to all of the abnormal object.

10. The inspection device according to claim 7, wherein the processor circuitry is further configured to:
set a plurality of the thresholds one for each of the plurality of abnormal types;
determine a plurality of the abnormal levels one for each of the plurality of abnormal types; and
specify that the target object is the abnormal object if the target object includes a part having a plurality of determined abnormal levels each equal to or more than a corresponding one of the plurality of thresholds.

11. The inspection device according to claim 8, wherein the processor circuitry is further configured to:
set a plurality of the thresholds one for each of the plurality of abnormal types;
determine a plurality of the abnormal levels one for each of the plurality of abnormal types; and
specify that the target object is the abnormal object if the target object includes a part having a plurality of determined abnormal levels each equal to or more than a corresponding one of the plurality of thresholds.

12. The inspection device according to claim 9, wherein the processor circuitry is further configured to:
set a plurality of the thresholds one for each of the plurality of abnormal types;
determine a plurality of the abnormal levels one for each of the plurality of abnormal types; and
specify that the target object is the abnormal object if the target object includes a part having a plurality of determined abnormal levels each equal to or more than a corresponding one of the plurality of thresholds.
